(19) United States
(12) Patent Application Publication
(10) Pub. No.: US 2010/0014211 A1
(43) Pub. Date: Jan. 21, 2010

(54) STORAGE BATTERY

(75) Inventor: Kanji Otsuka, Higashiyamato (JP)

Correspondence Address: WENDEROTH, LIND & PONACK, L.L.P., 1030 15th Street, N.W.,, Suite 400 East, Washington, DC, 20005-1503, US

(73) Assignee: TAMA-TLO LTD., TOKYO (JP)

(21) Appl. No.: 12/519,020

(22) PCT Filed: Dec. 13, 2007
(86) PCT No.: PCT/JP2007/073997

§ 371 Date: Jun. 12, 2009

(30) Foreign Application Priority Data
Dec. 14, 2006 (JP) 2006-336601

(51) Int. Cl. H01G 4/20; H01G 9/02

(52) U.S. Cl. 361/313; 361/525

(57) ABSTRACT

A storage battery of the present invention is a capacitor-type storage battery having a short charging time and a long life, and capable of realizing a high output voltage. The storage battery includes a metal sheet 10 connected to a first terminal 22, a first metamaterial film 13 formed on a front surface of the metal sheet 10, and a first conductive film 12 formed on the first metamaterial film 13 and connected to a second terminal 21. The first metamaterial film 13 is a polycrystalline semiconductor film, and in each of crystal grains constituting the polycrystalline semiconductor film, the inside is of a first conductivity type, and the vicinity of interface is of a second conductivity type. An oxide insulating film may be formed on a surface of the metal sheet 10.

### TECHNICAL FIELD

The present invention relates to a capacitor-type storage battery.

### BACKGROUND ART

Most of conventional storage batteries use an electrolyte.

### DISCLOSURE OF THE INVENTION

### Problems to be Solved by the Invention

When a storage battery uses an electrolyte, it takes a long time to charge the battery. Since the electrolyte deteriorates, the life of the storage battery is short. To realize a high output voltage, a plurality of storage batteries needs to be connected in series.

The present invention is made in view of the above problems, and an object of the present invention is to provide a capacitor-type storage battery having a short charging time and a long life, and capable of realizing a high output voltage.

### Means for Solving the Problems

To solve the above problems, a capacitor-type storage battery of the present invention includes:

a metal sheet connected to a first terminal;

a first metamaterial film formed on a front surface of the metal sheet; and

a first conductive film formed on the first metamaterial film and connected to a second terminal;

wherein the first metamaterial film is a polycrystalline semiconductor film, and in each of crystal grains constituting the polycrystalline semiconductor film, the inside is of a first conductivity type, and the vicinity of interface is of a second conductivity type.

Another capacitor-type storage battery of the present invention includes:

a metal sheet connected to a first terminal;

a first metamaterial film formed on a front surface of the metal sheet; and

a first conductive film formed on the first metamaterial film and connected to a second terminal;

wherein the first metamaterial film is a polycrystalline semiconductor film, and a metal layer is located at crystal interfaces in the polycrystalline semiconductor film.

Another capacitor-type storage battery of the present invention includes:

a metal sheet connected to a first terminal;

a first metamaterial film formed on a front surface of the metal sheet; and

a first conductive film formed on the first metamaterial film and connected to a second terminal;

wherein the first metamaterial film is a polycrystalline semiconductor film, and a crystal interface in the polycrystalline semiconductor film is oxidized to form an insulating layer.

Another capacitor-type storage battery of the present invention includes:

a metal sheet connected to a first terminal;

a first metamaterial film formed on a front surface of the metal sheet; and

a first conductive film formed on the first metamaterial film and connected to a second terminal;

wherein the first metamaterial film is a polycrystalline film of a metal, and an insulating layer, an intermetallic compound layer including the metal, or an alloy including the metal or impurity solid solution is located at a crystal interface in the polycrystalline film of the metal. The insulating layer includes an oxide of the metal, an organic insulator, and an inorganic insulator such as glass.

Another capacitor-type storage battery of the present invention includes:

a metal sheet connected to a first terminal;

a first metamaterial film formed on a front surface of the metal sheet; and

a first conductive film formed on the first metamaterial film and connected to a second terminal;

wherein the first metamaterial film has a structure in which a semiconductor layer of the first conductivity type and a semiconductor layer of the second conductivity type are alternately laminated by at least one layer each.

Another capacitor-type storage battery of the present invention includes:

a metal sheet connected to a first terminal;

a first metamaterial film formed on a front surface of the metal sheet; and

a first conductive film formed on the first metamaterial film and connected to a second terminal;

wherein the first metamaterial film has a structure in which a semiconductor film and a metal layer are alternately laminated by at least one layer each.

Another capacitor-type storage battery of the present invention includes:

a metal sheet connected to a first terminal;

a first metamaterial film formed on a front surface of the metal sheet; and

a first conductive film formed on the first metamaterial film and connected to a second terminal;

wherein the first metamaterial film has a structure in which a plurality of semiconductor films is laminated, and insulating layers are formed on surfaces of the semiconductor films.

Another capacitor-type storage battery of the present invention includes:

a metal sheet connected to a first terminal;

a first metamaterial film formed on a front surface of the metal sheet; and

a first conductive film formed on the first metamaterial film and connected to a second terminal;

wherein the first metamaterial film has a structure in which a conductor film having a thickness of between 10 nm and 100 nm inclusive and an insulating film having a thickness of between 2 nm and 10 nm inclusive are alternately laminated by at least one layer each.

A second metamaterial film formed on a rear surface of the metal sheet and

a second conductive film formed on the second metamaterial film may be included.

The second metamaterial film of the first example is a polycrystalline semiconductor film, and in each of crystal grains constituting the polycrystalline semiconductor film, the inside is of a first conductivity type, and the vicinity of crystal interface is of a second conductivity type.

The second metamaterial film of the second example is a polycrystalline semiconductor film, and a metal layer is located at a crystal interface in the polycrystalline semiconductor film.

The second metamaterial film of the third example is a polycrystalline semiconductor film, and a crystal interface in the polycrystalline semiconductor film is oxidized to form an insulating layer.

The second metamaterial film of the fourth example is a polycrystalline film of a metal, and an oxide layer of the metal or an intermetallic compound layer including the metal is located at a crystal interface in the polycrystalline film of the metal.

The second metamaterial film of the fifth example has a structure in which a semiconductor film of the first conductivity type and a semiconductor film of the second conductivity type are alternately laminated by at least one layer each.

The second metamaterial film of the sixth example has a structure in which a plurality of semiconductor films is laminated, and metal layers are located between layers of the plurality of semiconductor films.

The second metamaterial film of the seventh example has a structure in which a plurality of semiconductor films is laminated, and surfaces of the semiconductor films are oxidized to form insulating layers.

The second metamaterial film of the eighth example has a structure in which a conductor film having a thickness of between 10 nm and 100 nm inclusive and an insulating film having a thickness of between 2 nm and 10 nm inclusive are alternately laminated by at least one layer each.

It is preferred that a laminate of the metal film, the first and second metamaterial films, and the first and second conductive films be wound like a roll.

Another capacitor-type storage battery of the present invention includes:

a metal sheet connected to a first terminal;

a first metamaterial film formed on a front surface of the metal sheet; and

a first conductive film formed on the first metamaterial film and connected to a second terminal;

wherein the first metamaterial film is a polycrystalline semiconductor film, and a crystal interface in the polycrystalline semiconductor film is a p-n junction, a Schottky connection, or a tunnel connection.

It is preferred that an oxide insulating film be formed on the front surface of the metal sheet. In this case, the first metamaterial film is formed on the oxide insulating film.

### ADVANTAGES OF THE INVENTION

According to the invention, it is possible to provide a capacitor-type storage battery which does not use an electrolyte. Therefore, a charging time is short compared with a conventional storage battery. The life of the storage battery becomes long. Since an output voltage of the storage battery is determined by withstand voltages of the oxide insulating film and the metamaterial film, the output voltage of the storage battery can be increased compared with a conventional storage battery.

### BRIEF DESCRIPTION OF THE DRAWINGS

FIG. 1 is a cross-sectional view of a storage battery of an embodiment of the present invention.

FIG. 2 shows a relationship among types of polarization, polarizability and frequency.

### DESCRIPTION OF SYMBOLS

1: Storage sheet
10: Metal sheet
10a: Oxide insulating film
11, 12: Conductive film
13, 14: Metamaterial film
21, 22: Terminal
3: Reel of storage sheet

### BEST MODE FOR CARRYING OUT THE INVENTION

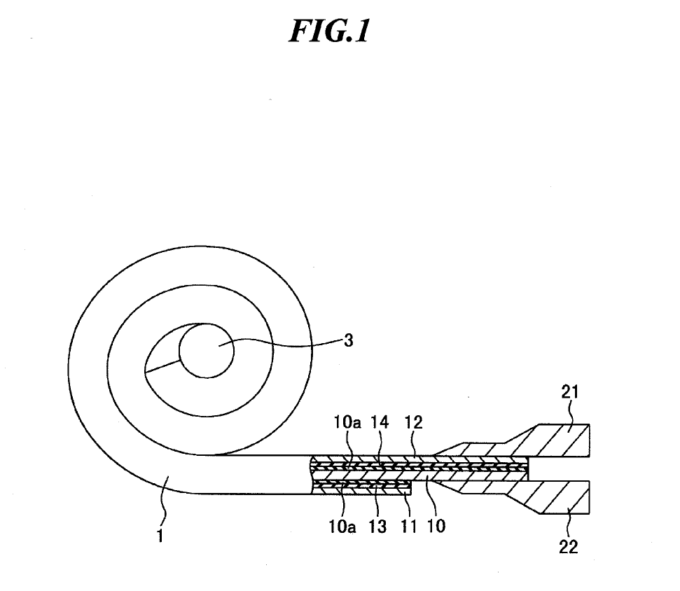

Hereinafter, an embodiment of the present invention will be described with reference to the drawings. FIG. 1 is a schematic view of a vertical cross-section of a capacitor-type storage battery of an embodiment of the present invention. The storage battery is formed by winding a storage sheet 1 around a reel 3 like a roll.

Apart of FIG. 1 shows a cross-section for illustrating a constitution of the storage sheet 1. The storage sheet 1 is made by oxidizing a front surface and a rear surface of a conductive sheet 10 to form oxide insulating films 10a, further forming metamaterial films 13, 14 on the two oxide insulating films 10a, and furthermore, forming conductive films 11, 12 on the metamaterial films 13, 14, respectively. The conductive sheet 10 is, for example, an Mg—Al alloy, and has a thickness of 0.1 μm to 200 μm. The oxide insulating film 10a is a thin film having a thickness of 10 nm or less and a structure of, for example, a spinel structure (cubic closest packing, 4:6:4 coordination, AB₂O₄), a rock salt structure (cubic closest packing, 6:6 coordination, AO), or a single or mixed crystal structure of a corundum type (hexagonal closest packing, 6:4 coordination, A2O3). The conductive films 11, 12 are metal films (for example, Al films) having a thickness of 0.05 to 5 μm, and formed by, for example, a sputtering method. When the conductive films 11, 12 are formed by another conductive material, the conductive films 11, 12 can be also formed by a CVD method.

The conductive film 12 is exposed at the end portion of the storage sheet 1. A terminal 21 for applying a voltage to the conductive film 12 is connected to this exposed portion. At the end portion of the rear surface of the storage sheet 1, the conductive film 11, the metamaterial film 13, and the oxide insulating film 10a are removed, and the conductive sheet 10 is exposed. A terminal 22 for applying the other voltage to the conductive sheet 10 is connected to this exposed portion. When a predetermined electric potential difference is applied between the terminals 21 and 22, the conductive films 11 and 12 become in a state of being contacted with each other, and a laminate structure of the conductive sheet 10, the oxide insulation film 10a, the metamaterial films 13, 14, and the conductive films 11, 12 functions as a capacitor, so that a charge is accumulated. When the conductive films 11, 12 are not contacted with each other in a wound state, the storage sheet 1 becomes a series capacitor connection circuit in which the conductive film 11 has an intermediate voltage, so that a charge is accumulated. Therefore, the storage sheet 1 has a metallic conduction compared with a conventional electric current via an electrolyte, so that a charging time becomes short compared with a conventional storage battery.

An upper limit of the electric potential difference between the terminals 21 and 22, namely an operating voltage of the storage battery, is determined by a total withstand voltage of the oxide insulating film 10a and the metamaterial films 13, 14. For example, when the oxide insulating film 10a is a magnesium oxide film having a thickness of 100 nm, an insulation withstand voltage of the oxide insulating film 10a is 1 kV. Although the withstand voltage of the meta material largely varies depending upon a film formation structure thereof, the withstand voltage is about several V to 100 V and added to the withstand voltage of the oxide insulating film. Therefore, an operating voltage of the storage battery can be increased compared with a conventional storage battery.

If the oxide insulating film 10a and the metamaterial films 13, 14 include a defect, when the electric potential difference between the terminals 21 and 22 is increased sufficiently higher than the operating voltage of the storage battery, an insulation breakdown occurs in an area where the defect is present, and an electric discharge is generated. By this electric discharge, the conductive film 11 located on the area where the defect is present is evaporated, so that it is possible for the area including the defect not to affect the operation of the storage battery.

Even when the conductive sheet 1 is wound like a roll as shown in FIG. 1, no electric problem occurs because the conductive films 11 and 12 contact to each other in the conductive sheet 1.

Next, a configuration of the metamaterial films 13, 14 and a manufacturing method thereof will be described using multiple examples. In the first example, the metamaterial films 13, 14 are polycrystalline semiconductor films. In each of crystal grains constituting the polycrystalline semiconductor film, the inside is of a first conductivity type (for example, n-type), and the vicinity of the crystal interface is of a second conductivity type (for example, p-type), so that the vicinity of the crystal interface in the polycrystalline semiconductor film is a p-n junction.

Such a configuration can be formed, for example, by the following process. First, a polycrystalline semiconductor film (for example, a polycrystalline silicon film) including impurities of the first conductivity type (for example, a group V impurity such as P) and impurities of the second conductivity type (for example, a group III impurity such as B) having a diffusion coefficient larger than that of the impurities of the first conductivity type is formed by the CVD method. This polycrystalline semiconductor film can be formed by introducing impurity gases (for example, B₂H₆ and PH₃) of each of the first conductivity type and the second conductivity type into a material gas (for example, a silane-based gas). In this condition, it is preferred that the conductivity type of the polycrystalline semiconductor film be neutral. Next, the polycrystalline semiconductor film is instantaneously heated (for example, laser annealed). As described above, among the impurities introduced into the polycrystalline semiconductor film, the second conductivity type has a diffusion coefficient larger than that of the first conductivity type. Therefore, the impurities of the first conductivity type move near a crystal grain interface of the polycrystalline semiconductor film, and in each of crystal grains constituting the polycrystalline semiconductor film, the inside is of the first conductivity type, and the vicinity of interface is of the second conductivity type. The reason why the impurities move near the crystal grain interface is that this condition is stable in energy. The polycrystalline semiconductor film may be a Ge film, an AIN film, a BN film, or a GaN film.

In the second example, the metamaterial films 13, 14 are polycrystalline semiconductor films, and a metal layer is located at crystal interfaces in the polycrystalline semiconductor films, so that the interfaces are Schottky-connected. The metal layer is formed on approximately entire areas of the crystal interfaces so that the adjacent crystals are not directly contacted with each other. The thickness of the metal layer is, for example, between 2 nm and 50 nm inclusive.

Such a configuration can be formed, for example, by the following process. First, a polycrystalline semiconductor film (for example, a polycrystalline silicon film) including a metal such as Cu or Al is formed. The number of atoms of the metal included in the polycrystalline semiconductor film is, for example, 10¹⁰ to 10²⁰/cm³. Next, a metal layer is formed on the crystal interface in the polycrystalline semiconductor film by instantaneously heating (for example, laser-annealing) the polycrystalline semiconductor film and moving the metal to a crystal grain interface of the polycrystalline semiconductor film. The reason why the metal moves to the crystal grain interface to form the metal layer by the instantaneous heating is that this condition is stable in energy. The polycrystalline semiconductor film may be a Ge film, an AIN film, a BN film, or a GaN film.

In the third example, the metamaterial films 13, 14 are polycrystalline semiconductor films, and the crystal interface in the polycrystalline semiconductor films is oxidized to form an insulating layer, so that the crystal interface is in a tunnel-connection. The thickness of the oxide layer is, for example, between 2 nm and 15 nm inclusive.

Such a configuration can be formed, for example, by the following process. First, a polycrystalline semiconductor film (for example, a polycrystalline silicon film) is formed by the CVD method. Next, the polycrystalline semiconductor film is instantaneously heated (for example, laser annealed) in an oxidizing atmosphere. In this way, the crystal interface is selectively oxidized to form an insulating layer on the crystal interface. The insulating layer is formed on approximately entire areas of the crystal interface so that the adjacent crystals are not directly contacted with each other. The polycrystalline semiconductor film may be a Ge film, an AIN film, a BN film, or a GaN film.

In the third example, when the oxides in the polycrystalline semiconductor films are formed by a material showing characteristics of semiconductor, the vicinity of the crystal interface can be a pn junction area, but not a tunnel connection area by introducing impurities of the first and second conductive types into the polycrystalline semiconductor films in the same way as that of the first example.

In the fourth example, the metamaterial films 13, 14 are polycrystalline films of a metal, and the oxide layer of the metal, which is an insulating layer, is located at a crystal interface in the polycrystalline film of the metal. The thickness of the oxide layer is, for example, between 2 nm and 15 nm inclusive. The oxide layer is formed on approximately entire areas of the crystal interface so that the adjacent crystals are not directly contacted with each other. The size of the metal crystal is, for example, between 50 nm and 5000 nm inclusive.

Such a configuration can be formed, for example, by the following process. First, a metal polycrystalline film is formed by the sputtering method. Next, the metal polycrystalline film is instantaneously heated (for example, laser annealed) in an oxidizing atmosphere. In this way, the crystal interface is selectively oxidized to form an oxide layer on the crystal interface. The metal is, for example, Ni, Fe, Cu, Al, Mg, Ag, Sn, or Cr.

An organic insulating film or an inorganic insulator such as glass may be located at the crystal interface on the polycrystalline film of the metal. Such a configuration can be formed, for example, by the following process. First, a dispersion material is coated on the surfaces of metal particles having a diameter of 50 nm to 5000 nm. The dispersion material suppresses coagulation of the metal particles, and a general dispersion material for suppressing coagulation of nano metal particles can be used. Next, the metal particles are introduced into a solution in which an organic insulator or an inorganic insulator is dissolved, and a solvent of the solution is evaporated. In this way, a metal polycrystalline film in which an organic insulating film or an inorganic insulator such as glass is located at the crystal interface thereof is formed.

In the fourth example, when the oxides in the polycrystalline metal films are formed by a material showing characteristics of semiconductor, the crystal interface can be Schottky-connected.

In the fifth example, the metamaterial films 13, 14 are polycrystalline films of a metal, and an intermetallic compound layer including the metal, or an alloy including the metal or impurity solid solution layer is located at the crystal interface in the polycrystalline film of the metal. Each of these layers is formed on approximately entire areas of the crystal interface so that the adjacent crystals are not directly contacted with each other. The thickness of the intermetallic compound layer, the alloy layer, or the impurity solid solution layer is, for example, between 2 nm and 15 nm inclusive.

Such a configuration can be formed, for example, by the following process. First, a metal polycrystalline film in which a second metal which forms an intermetallic compound with a first metal is added to the first metal is formed by the sputtering method. Next, the metal polycrystalline film is instantaneously heated (for example, laser annealed). In this way, the intermetallic compound layer is selectively formed from the crystal interface. The metal polycrystalline film is, for example, an alloy of Ni—Fe, Fe—Cr, Fe—Co, Al—Si, Al—Mg, Cu—Zn, Cu—Sn, or the like.

In the sixth example, the metamaterial films 13, 14 have a structure in which a semiconductor layer of the first conductivity type (for example, p-type) and a semiconductor layer of the second conductivity type (for example, n-type) are alternately laminated by at least one layer each, and an area between the semiconductor layer of the first conductivity type and the semiconductor layer of the second conductivity type is a p-n junction area. The thickness of the semiconductor layer of the first conductivity type and the semiconductor layer of the second conductivity type is, for example, between 2 nm and 100 nm inclusive.

Such a structure can be formed by alternately laminating the semiconductor layer of the first conductivity type (for example, a polycrystalline silicon film) and the semiconductor layer of the second conductivity type (for example, a polycrystalline silicon film) by the CVD method. This can be realized by introducing an impurity gas (for example, B₂H₆ or PH₃) of the first conductivity type or the second conductivity type into a material gas (for example, a silane-based gas). The lamination is repeated at least one time. The semiconductor layer may be a Ge film, an AIN film, a BN film, or a GaN film.

In the seventh example, the metamaterial films 13, 14 are formed by laminating a semiconductor film and a metal layer, so that an area between the semiconductor film and the metal layer is Schottky-connected area. Such a structure can be formed by repeatedly performing a step of forming a semiconductor film (for example, a polycrystalline silicon film) by the CVD method and a step of forming a metal layer on the semiconductor film by the sputtering method. The lamination is repeated at least one time. The semiconductor film may be a Ge film, an AIN film, a BN film, or a GaN film.

In the eighth example, the metamaterial films 13, 14 have a structure in which a plurality of semiconductor films is laminated, and insulating layers are formed on surfaces of the semiconductor films, so that the layers of the plurality of semiconductor films are connected by the tunnel-connection. Two or more layers of the semiconductor film are laminated.

Such a structure can be formed by repeatedly performing a step of forming a semiconductor film (for example, a polycrystalline silicon film) by the CVD method and a step of thermally oxidizing or plasma oxidizing the surface of the semiconductor film. The above steps are repeated at least one time. The semiconductor film may be a Ge film, an AIN film, a BN film, or a GaN film.

In the ninth example, the metamaterial films 13, 14 have a structure in which a conductor film having a thickness of between 10 nm and 100 nm inclusive and an insulating film having a thickness of between 2 nm and 10 nm inclusive are alternately laminated by at least one layer each. Such a structure can be formed by repeatedly performing a step of forming a conductor film (for example, a metal film) by the sputtering method and a step of thermally oxidizing or plasma oxidizing the surface of the conductor film. The above steps are repeated at least one time.

In any configuration, it is preferred that the metamaterial films 13, 14 have a relative permittivity of 1000 or more to increase capacity of the storage battery. It is further preferred that the metamaterial films 13, 14 have a relative permittivity of 1000 or more and a relative magnetic permeability of 10 or more to increase capacity of the storage battery. The metamaterial films 13, 14 may be a metamaterial film of the above described first to ninth examples, and metamaterial films 13, 14 may be different from one another (for example, the metamaterial film 13 is the one of the first example and the metamaterial film 14 is the one of the second example).

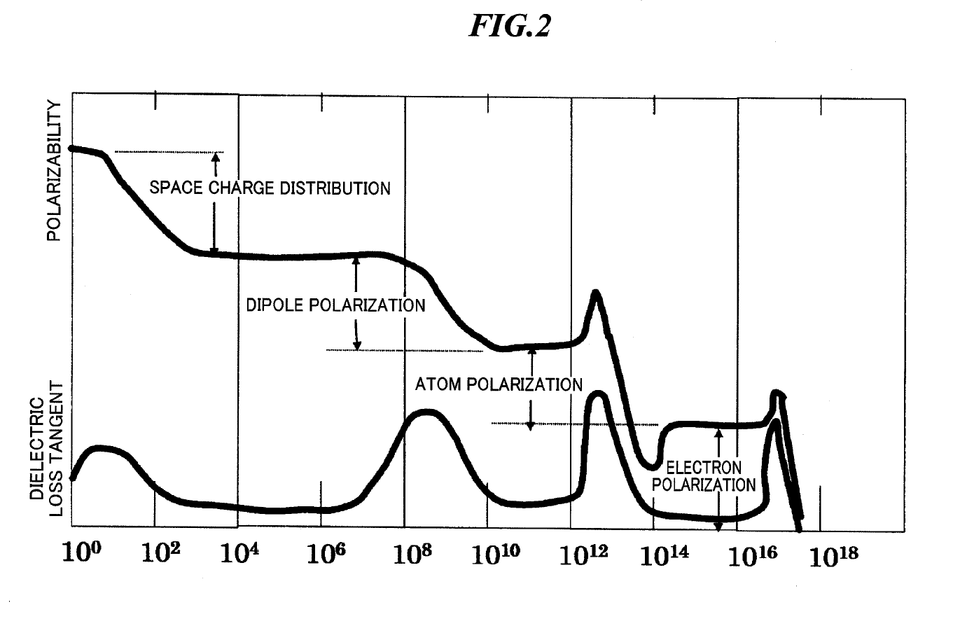

The above described metamaterial films 13, 14 have a high permittivity. This reason will be described with reference to FIG. 2. FIG. 2 shows types of polarization and polarization frequency characteristics. A phenomenon in which polarization occurs when carriers move in a semiconductor block of a certain size of volume as shown in FIG. 2 is called a polarization by space charge distribution. Since it takes time until the distribution condition settles, polarization occurs only when the frequency is low. The time for the carriers to move becomes long as the volume gets larger, the polarization occurs more often in a low frequency. However, in a capacitor-type storage battery, since an electric current is almost direct current, it is possible to take advantage of the effect that the polarization occurs in a low frequency.

By providing some barriers against charge migration between crystals with one crystal as one cell, a polarization without implementation problem can be realized. There are barriers of pn-junction, Schottky-junction, tunnel-connection, and the like in a semiconductor. The same effect can be attained by forming, for example, a thin insulating layer having a thickness of 10 nm or less on an interface of a polycrystalline particle, for a metal, alloy, or intermetallic compound having an electric resistance. In a counter electrode as in a capacitor, the barrier may spread infinitely in parallel with an electrode of the cell, and the same effect can be obtained when a layered structure is employed.

A specific example of the cell will be described. Lengths at a right angle to the electric potential will be shown in a layered structure. The oxide insulating layer 10a is 10 nm or less, the purpose of this is voltage resistance, and preferably it be 5 nm in a capacitor used at 100 V. Since the thickness of the metamaterial film corresponds to a time of fast charge/fast discharge, an appropriate thickness of one cell is about 10 nm to 100 nm. The effective relative permittivity is about 1000 to 1000000. By using the above thickness, one layered structure to ten layered structure can be appropriate. To limit polarization in a planar direction against dynamic changes in electrical potential, polycrystal is preferred. When the metamaterial film is about 100 nm, a sufficient flexibility can be obtained, and there is no structural problem. The voltage resistance increases in proportion to the number of consecutive crystal grains in Z direction between electrodes.

Next, an example of a manufacturing method of the storage battery shown in FIGS. 1 and 2 will be described. First, a conductive sheet 10 is manufactured. Next, the front surface and the rear surface of the conductive sheet 10 are oxidized to form oxide insulating films 10a. This oxidization processing is performed by, for example, a plasma oxidization method or a thermal oxidization method. At this time, it is preferred that an oxide insulating film 10a be not formed at the end portion of the conductive sheet 10.

Next, the metamaterial films 13, 14 are formed on the conductive sheet 10 by the above described method. Next, conductive films 11, 12 are formed on the metamaterial films 13, 14 by the sputtering method or the like. Thereafter, a terminal 22 is connected to the conductive sheet 10 and a terminal 21 is connected to the conductive film 11.

According to the present invention, it is possible to provide a capacitor-type storage battery which does not use an electrolyte. Therefore, a charging time becomes short compared with a conventional storage battery. In addition, the life of the storage battery becomes long. Furthermore, not only an output voltage of the storage battery is determined by the withstand voltage of the oxide insulating film, but also an amount of storage increases by the effect of a high-permittivity layer of the metamaterial films 13, 14, so that the output voltage of the storage battery can be increased compared with a conventional storage battery, as follows. Amount of storage [kWh]=(½)CV². Here, C=A∈ᵣ∈ₒ/d. C is capacity [F], V is voltage [V], A is area of electrode [m²], d is thickness of dielectric body [m], ∈ᵣ is relative permittivity, ∈ₒ is permittivity in vacuum [F/m]=8.854×10⁻¹². The capacity between the conductive sheet 10 and the conductive film 11 in FIG. 1 is C=1/{(1/C₁)+(1/C₂)}=A∈₀(∈ᵣ₁∈ᵣ₂)/{d₁∈ᵣ₂+d₂∈ᵣ₁}. Here, C1 is capacity of the oxide insulating film 10a, and C2 is capacity of the metamaterial film 13.

Note that the present invention is not limited to the above described embodiment, and various modifications are possible without departing from the gist of the invention, to implement the present invention. For example, the metamaterial film may have a configuration in which the insulation is atomic level, but not the tunnel connection.

In the above described embodiment, the inventions below are also described.

(1) A manufacturing method of a capacitor-type storage battery, comprising the steps of:

forming a first metamaterial film on a surface of a metal sheet;

forming a first conductive film on the first metamaterial film; and

connecting a first terminal to the metal sheet and connecting a second terminal to the conductive film;

wherein the step of forming the first metamaterial film includes the steps of:

forming a polycrystalline semiconductor film including impurities of a first conductivity type and impurities of a second conductivity type having a diffusion coefficient larger than that of the impurities of the first conductivity type; and

making each of crystal grains constituting the polycrystalline semiconductor film so that the inside is of the first conductivity type and the vicinity of interface is of the second conductivity type, by laser-annealing the polycrystalline semiconductor film to move the impurities of the first conductivity type near the crystal grain interface of the polycrystalline semiconductor film.

(2) A manufacturing method of a capacitor-type storage battery, comprising the steps of:

forming a first metamaterial film on a surface of a metal sheet;

forming a first conductive film on the first metamaterial film; and

connecting a first terminal to the metal sheet and connecting a second terminal to the conductive film;

wherein the step of forming the first metamaterial film includes the steps of:

forming a polycrystalline semiconductor film including a metal; and

forming a metal layer on a crystal interface in the polycrystalline semiconductor film, by laser-annealing the polycrystalline semiconductor film to move the metal to the crystal grain interfaces of the polycrystalline semiconductor film.

(3) A manufacturing method of a capacitor-type storage battery, comprising the steps of:

forming a first metamaterial film on a surface of a metal sheet;

forming a first conductive film on the first metamaterial film; and

connecting a first terminal to the metal sheet and connecting a second terminal to the conductive film;

wherein the step of forming the first metamaterial film includes the steps of:

forming a polycrystalline semiconductor film; and

oxidizing a crystal interface in the polycrystalline semiconductor film to form an insulating layer, by laser-annealing the polycrystalline semiconductor film in an oxidizing atmosphere.

(4) A manufacturing method of a capacitor-type storage battery, comprising the steps of:

forming a first metamaterial film on a surface of a metal sheet;

forming a first conductive film on the first metamaterial film; and

connecting a first terminal to the metal sheet and connecting a second terminal to the conductive film;

wherein the step of forming the first metamaterial film includes the steps of:

forming a polycrystalline metal film; and

oxidizing a crystal interface in the polycrystalline metal film to form an insulating layer, by laser-annealing the polycrystalline metal film in an oxidizing atmosphere.

(5) A manufacturing method of a capacitor-type storage battery, comprising the steps of:

forming a first metamaterial film on a surface of a metal sheet;

forming a first conductive film on the first metamaterial film; and

connecting a first terminal to the metal sheet and connecting a second terminal to the conductive film;

wherein the step of forming the first metamaterial film includes the steps of:

forming a polycrystalline metal film in which a second metal which forms an intermetallic compound with a first metal is mixed with the first metal; and

forming an intermetallic compound layer, an alloy layer, or an impurity solid solution layer on a crystal interface in the polycrystalline metal film, by laser-annealing the polycrystalline metal film.

(6) A manufacturing method of a capacitor-type storage battery, comprising the steps of:

forming a first metamaterial film on a surface of a metal sheet;

forming a first conductive film on the first metamaterial film; and

connecting a first terminal to the metal sheet and connecting a second terminal to the conductive film;

wherein the step of forming the first metamaterial film includes the steps of:

forming a first semiconductor film of a first conductivity type; and

forming a second semiconductor film of a second conductivity type on the first semiconductor film.

(7) A manufacturing method of a capacitor-type storage battery, comprising the steps of:

forming a first metamaterial film on a surface of a metal sheet;

forming a first conductive film on the first metamaterial film; and

connecting a first terminal to the metal sheet and connecting a second terminal to the conductive film;

wherein the step of forming the first metamaterial film includes the steps of:

forming a semiconductor film; and

forming a metal film on the semiconductor film.

(8) A manufacturing method of a capacitor-type storage battery, comprising the steps of:

forming a first metamaterial film on a surface of a metal sheet;

forming a first conductive film on the first metamaterial film; and

connecting a first terminal to the metal sheet and connecting a second terminal to the conductive film;

wherein the step of forming the first metamaterial film includes the steps of:

forming a first semiconductor film;

forming an oxide insulating film on a surface of the first semiconductor film; and

forming a second semiconductor film on the oxide insulating film.

(9) A manufacturing method of a capacitor-type storage battery, comprising the steps of:

forming a first metamaterial film on a surface of a metal sheet;

forming a first conductive film on the first metamaterial film; and

connecting a first terminal to the metal sheet and connecting a second terminal to the conductive film;

wherein the step of forming the first metamaterial film includes the steps of:

forming a conductor film of at least 10 nm and at most 100 nm; and

forming an insulating film having a thickness of between 2 nm and 10 nm inclusive on the conductor film.

### INDUSTRIAL APPLICABILITY

The present invention relates to a capacitor-type storage battery having a short charging time and a long life, and capable of realizing a high output voltage.

1-19. (canceled)

20. A capacitor-type storage battery comprising:
a metal sheet connected to a first terminal;
a first oxide insulating film is formed on a front surface of said metal sheet;
a first metamaterial film formed on a surface of said first oxide insulating film; and
a first conductive film formed on said first metamaterial film and connected to a second terminal;
wherein said first metamaterial film is a polycrystalline semiconductor film, and in each of crystal grains constituting said polycrystalline semiconductor film, an inside thereof is of a first conductivity type, a vicinity of interface thereof is of a second conductivity type and a crystal interface in said polycrystalline semiconductor film is a p-n junction.

21. A capacitor-type storage battery comprising:
a metal sheet connected to a first terminal;
a first oxide insulating film is formed on a front surface of said metal sheet;
a first metamaterial film formed on a surface of said first oxide insulating film; and
a first conductive film formed on said first metamaterial film and connected to a second terminal;
wherein said first metamaterial film is a polycrystalline semiconductor film, a metal layer is located at a crystal interface in said polycrystalline semiconductor film and said crystal interface in said polycrystalline semiconductor film is a Schottky connection.

22. A capacitor-type storage battery comprising:
a metal sheet connected to a first terminal;
a first oxide insulating film is formed on a front surface of said metal sheet;
a first metamaterial film formed on a surface of said first oxide insulating film; and
a first conductive film formed on said first metamaterial film and connected to a second terminal;
wherein said first metamaterial film is a polycrystalline semiconductor film, a crystal interface in said polycrystalline semiconductor film is oxidized to form an insulating layer and said crystal interface in said polycrystalline semiconductor film is a tunnel connection.

23. A capacitor-type storage battery comprising:
a metal sheet connected to a first terminal;
a first oxide insulating film is formed on a front surface of said metal sheet;
a first metamaterial film formed on a surface of said first oxide insulating film; and
a first conductive film formed on said first metamaterial film and connected to a second terminal;
wherein said first metamaterial film is a polycrystalline grain of a metal, and an oxide layer of said each metal of crystal grains, a insulating layer having a thickness of between 2 nm and 15 nm inclusive, an intermetallic compound layer including said metal, or an alloy layer including said metal or impurity solid solution layer is located at a crystal interface in said polycrystalline grain of said metal.

24. A capacitor-type storage battery comprising:
a metal sheet connected to a first terminal;
a first oxide insulating film is formed on a front surface of said metal sheet;
a first metamaterial film formed on a surface of said first oxide insulating film; and
a first conductive film formed on said first metamaterial film and connected to a second terminal;
wherein said first metamaterial film has a structure in which a semiconductor layer of a first conductivity type and a semiconductor layer of a second conductivity type are alternately laminated by at least one layer each,
wherein an area between the semiconductor layer of the first conductivity type and the semiconductor layer of the second conductivity type is a p-n junction area.

25. A capacitor-type storage battery comprising:
a metal sheet connected to a first terminal;
a first oxide insulating film is formed on a front surface of said metal sheet;
a first metamaterial film formed on a surface of said first oxide insulating film; and
a first conductive film formed on said first metamaterial film and connected to a second terminal;
wherein said first metamaterial film has a structure in which a semiconductor film and a metal layer are alternately laminated by at least one layer each,
wherein an area between the semiconductor film and the metal layer is Schottky-connected area.

26. A capacitor-type storage battery comprising:
a metal sheet connected to a first terminal;
a first oxide insulating film is formed on a front surface of said metal sheet;
a first metamaterial film formed on a surface of said first oxide insulating film; and
a first conductive film formed on said first metamaterial film and connected to a second terminal;
wherein said first metamaterial film has a structure in which a plurality of semiconductor films is laminated, and insulating layers are formed on surfaces of said semiconductor films,
wherein said semiconductor films are a tunnel connection.

27. A capacitor-type storage battery comprising:
a metal sheet connected to a first terminal;
a first oxide insulating film is formed on a front surface of said metal sheet;
a first metamaterial film formed on a surface of said first oxide insulating film; and
a first conductive film formed on said first metamaterial film and connected to a second terminal;
wherein said first metamaterial film has a structure in which a conductor film having a thickness of between 10 nm and 100 nm inclusive and an insulating film having a thickness of between 2 nm and 10 nm inclusive are alternately laminated by at least one layer each.

28. The storage battery according to claim 20, further comprising:
a second oxide insulating film is formed on a rear surface of said metal sheet;
a second metamaterial film formed on said second oxide insulating film; and
a second conductive film formed on said second metamaterial film;
wherein said second metamaterial film is a polycrystalline semiconductor film, and in each of crystal grains constituting said polycrystalline semiconductor film, an inside thereof is of a first conductivity type, a vicinity of interface thereof is of a second conductivity type and a crystal interface in said polycrystalline semiconductor film is a p-n junction.

29. The storage battery according to claim 20, further comprising:
a second oxide insulating film is formed on a rear surface of said metal sheet;
a second metamaterial film formed on said second oxide insulating film; and
a second conductive film formed on said second metamaterial film;
wherein said second metamaterial film is a polycrystalline semiconductor film, a metal layer is located at a crystal interface in said polycrystalline semiconductor film and said crystal interface in said polycrystalline semiconductor film is a Schottky connection.

30. The storage battery according to claim 20, further comprising:
a second oxide insulating film is formed on a rear surface of said metal sheet;
a second metamaterial film formed on said second oxide insulating film; and
a second conductive film formed on said second metamaterial film;
wherein said second metamaterial film is a polycrystalline semiconductor film, a crystal interface in said polycrystalline semiconductor film is oxidized to form an insulating layer and said crystal interface in said polycrystalline semiconductor film is a tunnel connection.

31. The storage battery according to claim 20, further comprising:
a second oxide insulating film is formed on a rear surface of said metal sheet;
a second metamaterial film formed on said second oxide insulating film; and
a second conductive film formed on said second metamaterial film;
wherein said second metamaterial film is a polycrystalline film of a metal, and an oxide layer of said metal, an insulating layer having a thickness of between 2 nm and 15 nm inclusive, an intermetallic compound layer including said metal, or an alloy layer including said metal or impurity solid solution layer is located at a crystal interface in said polycrystalline film of said metal.

32. The storage battery according to claim 20, further comprising:
a second oxide insulating film is formed on a rear surface of said metal sheet;
a second metamaterial film formed on said second oxide insulating film; and
a second conductive film formed on said second metamaterial film;
wherein said second metamaterial film has a structure in which a semiconductor film of a first conductivity type and a semiconductor film of a second conductivity type are alternately laminated by at least one layer each,
wherein an area between the semiconductor film of the first conductivity type and the semiconductor film of the second conductivity type is a p-n junction area.

33. The storage battery according to claim 20, further comprising:
a second oxide insulating film is formed on a rear surface of said metal sheet;
a second metamaterial film formed on said second oxide insulating film; and
a second conductive film formed on said second metamaterial film;
wherein said second metamaterial film has a structure in which a semiconductor film and a metal layer are alternately laminated by at least one layer each,
wherein an area between the semiconductor film and the metal layer is Schottky-connected area.

34. The storage battery according to claim 20, further comprising:
a second oxide insulating film is formed on a rear surface of said metal sheet;
a second metamaterial film formed on said second oxide insulating film; and
a second conductive film formed on said second metamaterial film;
wherein said second metamaterial film has a structure in which a plurality of semiconductor films is laminated, and surfaces of said semiconductor films are oxidized to form insulating layers,
wherein said semiconductor films are a tunnel connection.

35. The storage battery according to claim 20, further comprising:
a second oxide insulating film is formed on a rear surface of said metal sheet;
a second metamaterial film formed on said second oxide insulating film; and
a second conductive film formed on said second metamaterial film;
wherein said second metamaterial film has a structure in which a conductor film having a thickness of between 10 nm and 100 nm inclusive and an insulating film having a thickness of between 2 nm and 10 nm inclusive are alternately laminated by at least one layer each.

36. The storage battery according to claim 28, wherein a laminate of said metal film, said first and second metamaterial films, and said first and second conductive films is wound like a roll.
